(19) United States
(12) Patent Application Publication
(10) Pub. No.: US 2006/0069988 A1
(43) Pub. Date: Mar. 30, 2006

(54) Methods and devices for printing graphical works

(75) Inventor: Martin Bailey, Cambridge (GB)

Correspondence Address: DARBY & DARBY P.C., P. O. BOX 5257, NEW YORK, NY, 10150-5257, US

(73) Assignee: GLOBAL GRAPHICS SOFTWARE LIMITED, Cambridge (GB)

(21) Appl. No.: 11/232,505

(22) Filed: Sep. 21, 2005

Related U.S. Application Data
(60) Provisional application No. 60/613,911, filed on Sep. 28, 2004.

(51) Int. Cl. G06F 17/21; G06K 15/00

(52) U.S. Cl. 715/521; 358/1.18

(57) ABSTRACT

A method of printing a graphical work on a medium includes providing a file comprising the graphical work and at least one boundary associated with the graphical work. The graphical work and an indication of at least one of the boundaries are printed onto the medium.

### CROSS REFERENCE TO RELATED APPLICATIONS

This Application claims priority under 35 USC 119(e) to U.S. Provisional Patent Application No. 60/613,911, filed on Sep. 28, 2004, which application is incorporated herein by reference in its entirety.

### FIELD

The present inventions are directed to the area of methods and devices for printing graphical works. In addition, the present inventions are directed to the area of methods and device for printing graphical works and one or more boundaries associated with the graphical work to assist in evaluation of the printing process and layout.

### BACKGROUND

A digital file describing a graphical work that can be submitted for printing will often include, in addition to the graphical work, a variety of marks or notations beyond those that will appear on the final, printed piece. These may include annotations such as color bars intended to allow an evaluation as to whether the contents have been correctly proofed or printed, a slug-line including contact information for the creator of the graphical work, and the like. Other marks or notations may indicate elements of the page, such as tinted backgrounds or graphical works that bleed off the page so that the normal minor variations in position of the paper on the printing press do not introduce a white, unprinted, margin around the edge of the trimmed page.

In addition, many files submitted for printing are set up with a nominal “page area” that is larger than the area that is intended to become the final, printed and trimmed page, or when the graphical work is intended to be placed as an element within the context of a complete page incorporating other items (as would be the case, for instance, when a half-page magazine advertisement is supplied). It is generally desirable to accurately print the graphical work on a medium, such as paper, in the proper configuration.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates a page layout with graphical works and boundaries associated with the graphical works, according to the inventions;

FIG. 2 illustrates a page layout with graphical works and tick marks representing the boundaries, according to the inventions;

FIG. 3 illustrates a page layout with graphical works and boundary notations, according to the inventions; and

FIG. 4 illustrates a page layout with graphical works and partial boundary lines to identify boundaries, according to the inventions.

### DETAILED DESCRIPTION

The present inventions are directed to the area of methods and devices for printing graphical works. In addition, the present inventions are directed to the area of methods and device for printing graphical works and one or more boundaries associated with the graphical work to assist in evaluation of the printing process and layout.

Computers and similar devices are often used to print graphical works. Such works can include, but are not limited to, photographic or video images, artwork, paintings, drawings, sketches, designs, graphics, cartoons, illustrations, other pictorial or graphical representations, and the like. The graphical work can include text as part of the work, for example, as part of an artwork, illustration or cartoon or as a caption for the graphical work.

The graphical work is generally contained in a digital file for storage, manipulation, viewing, and printing by a computer or other device. Software on the computer or other device can be used to view, manipulate, or print the graphical work from the digital file. Examples of such software include, but are not limited to, Adobe™ Acrobat™, QuarkXPress™, Jaws PDF Editor, Adobe™ InDesign™, Adobe™ Illustrator™, Adobe™ PhotoShop™, Microsoft™ Word, and the like. Any type of computing device, such as a personal computer, terminal, server, or the like, can be used to store, manipulate, view, or print the graphical work. The computing device typically includes a processor for executing the software and memory. Any type of memory can be used including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The digital file can be provided-to the computing device in any manner including, for example, wireless or wire transmission to the computing device; transmission using a storage medium such as, for example, flash memory sticks or cards, CD-ROM, DVD, magnetic media, or the like; or the graphical work can be designed on the computing device.

The computing device typically includes a display and one or more input devices, such as a keyboard, mouse, track ball, and the like. The computing device can display the graphical work on the display so that a user can view the graphical work to prepare, manipulate, or preview the graphical work prior to printing.

The computing device can also communicate with a printing device for printing the graphical work. Such communication can occur in any manner including communication over wires or cables or by wireless methods. Any type of printing device can be used including, but not limited to, laser printers, ink jet printers, imagesetter, platesetter, and the like. The printing device can be a black and white printer or a color printer.

The graphical work can be printed on any medium. Examples of suitable media include paper, plastic, metal, glass, fabric, wood, and the like.

Some digital file formats, such as the Portable Document Format (PDF) published by Adobe Systems, allow metadata or other information to be embedded within the file in such a way that it does not appear in a printed representation of the file. As an alternative, boundary information can be stored in a separate file. This information or metadata can-be used to describe one or more boundaries that represent areas, often, rectangular areas, or “page boxes,” which can be used in laying out the graphical work on the medium. This information or metadata can be extracted and used by software that acts on the digital files. For example, the information or metadata can be used to compose multiple pages together for the creation of a printing plate or to place partial page submissions within the context of a more complete page.

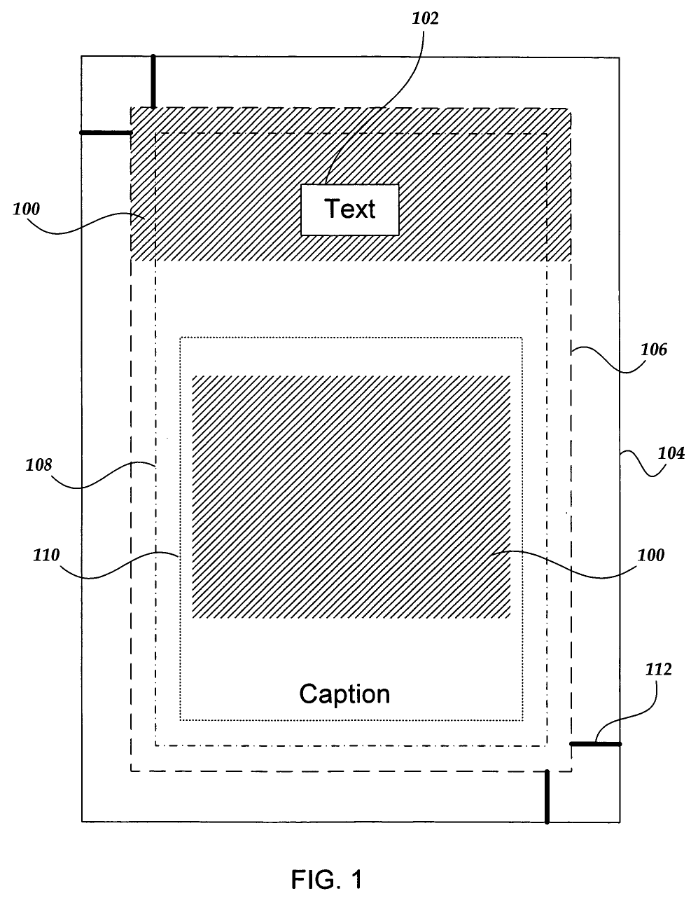

Graphical works 100 and text 102 are illustrated in FIG. 1. Examples of boundaries include a media boundary 104, a trim boundary 108, a bleed boundary 106, an art boundary 110, and a crop boundary (not shown). These boundaries can be useful in page layout and for proofing and examining the printed page prior to the final printing or trimming of the printed graphical work. For any graphical work, one or more of these boundaries may be defined and the corresponding information regarding the boundaries stored as part of the digital file containing the graphical work or in a separate digital file associated with the graphical work. In some embodiments, one or more of the boundaries, or portions of one or more of the boundaries, may be the same. For example, the art boundary and the trim boundary may be the same along one or more (or all) of the sides of the graphical work. Moreover, one or more of the boundaries may not be defined for a particular graphical work. For example, a bleed boundary may not be defined for graphical works that do not bleed off the page.

The media boundary 104 generally corresponds to the area of the physical medium on which the graphical work is to be printed. In the PDF file format, the media boundary corresponds to the MediaBox metadata.

A trim boundary 108 generally corresponds to the final, trimmed, printed piece. In the PDF file format, the trim boundary corresponds to the TrimBox metadata. The bleed boundary 106 typically corresponds to a region that extends beyond the trim boundary to accommodate portions of the graphical work that bleed off the trimmed page so that the normal minor variations in position of the paper on the printing press do not introduce a white, unprinted, margin around the edge of the trimmed page. In the PDF file format, the bleed boundary corresponds to BleedBox metadata.

An art boundary 110 typically defines the extent of the graphical work, including any desired white space that should be placed on a page when the file represents less than a full page, for example, a partial-page ad for a magazine. In the PDF file format this corresponds to the ArtBox metadata. The crop boundary typically corresponds to the region to which the contents of the page are to be clipped or cropped when displayed or printed. This corresponds to the CropBox metadata in the PDF file format.

In some cases, there may be marks 112 included in the file that are printed with the graphical work 100. Examples of such marks include trim marks to show the position of the corners of the area that the final pages should be trimmed to. These may not be recognizable by computer software, but are often intended to be read and interpreted by a human viewer. Where a file contains both such printable marks and boundary metadata, there is no guarantee that the two sets of data will convey exactly the same information, i.e., that the printable marks and the boundary metadata will be positioned correctly with respect to each other.

A publisher or print service provider will often ‘preflight’, proof, or test digital files that they receive for printing to validate that one or more aspects of the digital file conform to their specifications for printing. Examples of such aspects include determining that the embedded boundaries have the correct size; determining that the trim boundary 108 has the right dimensions for the expected size of the printed piece; determining that the difference between the trim boundary 108 and bleed boundary 106 is large enough to account for the expected variation of print position upon printing; and determining that all the graphical works of the final printed piece fall within the trim boundary. In the last case, there is often a specification that key items, such as text, fall at least a certain distance from the edge of the trim boundary 108 so that the normal variation of registration between the printed sheets and the trimming machinery does not lead to such items being inadvertently trimmed off and lost.

This test by the publisher or print service provider is often performed manually, typically by viewing the page on a computer monitor using a software application that can show both the artwork and the boundaries. Alternatively, the page may be printed on a proof printer and overlaid with a transparent sheet on which the correct size of art boundary, trim boundary, and bleed boundary are pre-marked. The latter mechanism is not, however, tied to any embedded metadata or other digital information about the boundaries, and is generally only successful when later stages in the workflow, such as placing the page in an imposition layout, or positioning a supplied graphical work within a larger page, are also manual. Allying manual testing with automated placement of pages can lead to poor, and possibly unacceptable, results, if the boundary information or metadata does not exactly replicate the manual positioning of the transparent overlay.

Moreover, manual steps increase the time taken to process files and increase the staffing levels required, thereby increasing costs. A manual placement of a page or graphical work also risks incorrect placement, for example, when the graphical work includes large amounts of white space around the design itself.

The manual determination of correctness of boundaries using an overlay on hard-copy proof prints, or by visual checking on screen also requires manual recording of an operator's approval of that correctness, and leaves the question of correctness open to later queries.

While it can be relatively easy to determine that the boundaries are of the correct size, or that the relationship between the boundaries is appropriate, it is, however, much more difficult to check automatically that the boundaries are placed correctly in relation to the graphical work for the page.

The present inventions generally relate to methods of printing boundaries or indication of boundaries, as well as methods of testing and recording the results of boundaries. The size or position (or both) of each of the boundaries can be embedded within or otherwise associated with a file and can be automatically or selectively printed or otherwise indicated on the proof print itself. This may be done in a variety of ways including printing on the proof print an indication of one or more of the boundaries, such as the boundaries themselves, portions of the boundaries, tick marks corresponding to the boundaries, numerical values for the size of the boundaries, separation distances between the boundaries, and the like.

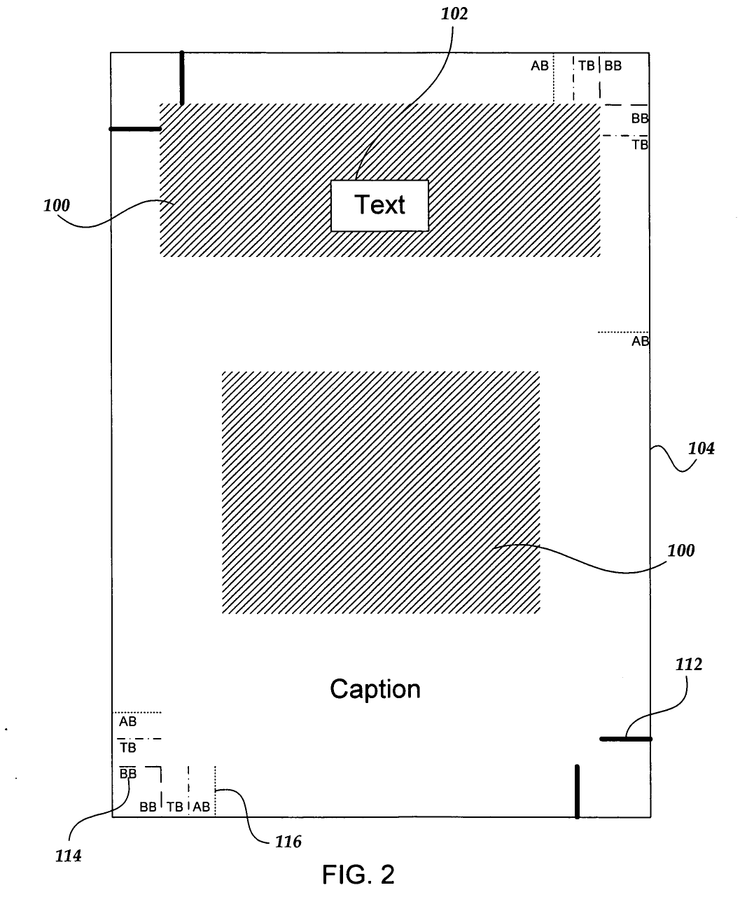

Examples of suitable methods for indicating boundaries on printed media include, for example, tick marks 116 at the edges of the proof print, aligned with the edges of the boundaries, as illustrated, for example, in FIG. 2. Such tick marks can be similar to those added as artwork elements to mark the corners of pages when printing from a number of page design applications, or by imposition programs at the corners of pages within an imposition layout.

Although it may be apparent based on placement of the tick marks which tick marks correspond to a particular boundary, the tick marks 116 can be differentiated from each other, if desired. A variety of methods can be used for differentiating the tick marks and one or more methods can be used. For example, notations 114 can be used such as, AB for art boundary, TB for trim boundary, and BB for bleed boundary and can be placed near the tick marks. The tick marks can also be differentiated by color, line style (full, dotted, dashed, etc.), thickness of the tick marks, and the like. Optionally, a legend can be provided in an unused portion of the page to identify which tick marks represent particular boundaries.

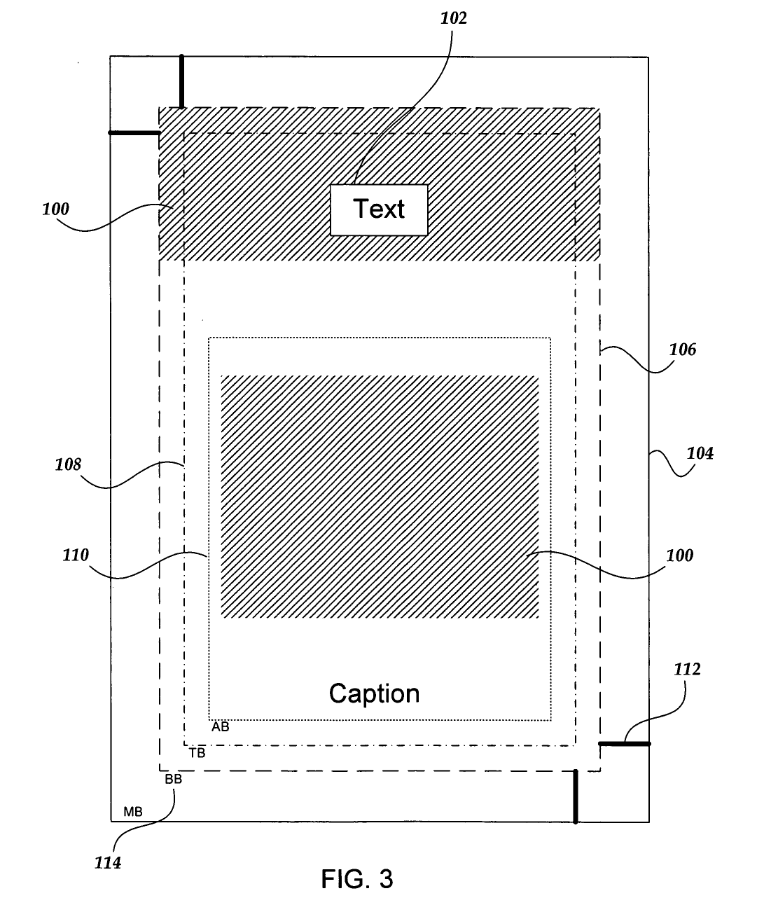

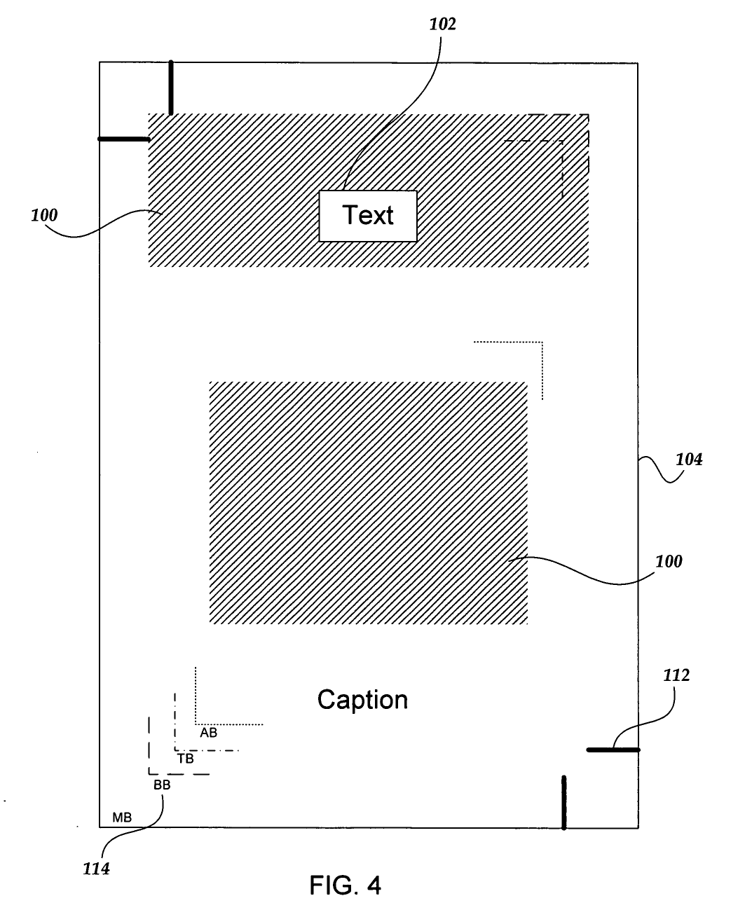

In another embodiment, one or more of the boundaries are printed on the proof page, as illustrated in FIG. 3. These boundaries can be differentiated, if desired, by using notations 114, different colors, different line styles, different line thickness, and the like or any combination of these or other differentiation techniques. In yet another embodiment, only a portion or portions of the one or more of the boundaries are printed, as illustrated, for example, in FIG. 4. Again, these portions can be differentiated, if desired, using any technique including, but not limited to, those techniques described above.

In another embodiment, the size of the boundaries, such as the art boundary, trim boundary, or other boundary, can be printed numerically in one or more units of measurement along the edge of the proof print. Additionally or alternatively, the separation distance between two boundaries can be printed. For example, the separation between the bleed boundary and the art boundary or trim boundary can be printed. If the size of the boundary or the separation distance between boundaries is different along different dimensions of the page (for example, along the top, bottom, left margin, or right margin of the page), the boundary size or separation distance along each edge can be printed.

The operator can review the printed dimensions, tick marks, boundaries, partial boundaries, or other boundary indications to check that the boundaries recorded for the graphical work are appropriate. As one alternative, or in addition to the preceding review, the operator can use a transparent overlay on which boundaries corresponding to the printed dimensions, tick marks or partially printed boundaries are already marked to check that the boundaries recorded in the file are appropriate. An advantage of at least some embodiments is that no guesswork is required to determine exactly where the designer or supplier of the graphical work intended the boundaries to fall in relation to the graphical work itself (provided, of course, that the designer or supplier is the one who defined the boundaries.) In addition, the boundary metadata/information (e.g., numerical data, tick marks, boundaries, or portions of boundaries) printed on the proof is taken from the same data that may be used in later stages of the workflow for automated imposition, or for automated placement of partial page submissions within a more complete page. The positions, sizes, and relationships of the page boundaries can be recorded on a hard-copy proof which may be filed and used later in the event of any dispute between the designer/supplier of the graphical work and the print service provider or publisher. Color proofs from received digital files containing graphical works are often routinely filed by some print service providers and publishers for use in researching and resolving disputes that may arise later around other issues, such as color reproduction.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of printing a graphical work on a medium, the method comprising:
providing a file comprising the graphical work and at least one boundary associated with the graphical work;
printing the graphical work; and
printing an indication of the at least one boundary onto the medium.

2. The method of claim 1, wherein providing a file comprises providing a file comprising the graphical work and at least two boundaries associated with the graphical work and wherein printing an indication comprises printing indications of the at least two boundaries onto the medium.

3. The method of claim 1, wherein the at least one boundary comprises a trim boundary.

4. The method of claim 1, wherein the at least one boundary comprises a media boundary.

5. The method of claim 1, wherein the at least one boundary comprises a crop boundary.

6. The method of claim 1, wherein the at least one boundary comprises a bleed boundary.

7. The method of claim 1, wherein the at least one boundary comprises an art boundary.

8. The method of claim 1, wherein printing an indication comprises printing the at least one boundary on the medium.

9. The method of claim 1, wherein printing an indication comprises printing a portion of the at least one boundary on the medium.

10. The method of claim 1, wherein printing an indication comprises printing tick marks suggesting the at least one boundary on the medium.

11. The method of claim 1, wherein printing an indication comprises printing an annotation identifying the at least one boundary on the medium.

12. The method of claim 1, wherein printing an indication comprises printing a numerical size of the at least one boundary on the medium.

13. The method of claim 1, wherein providing a file comprises providing a file comprising the graphical work and at least two boundaries associated with the graphical work and wherein printing an indication comprises printing a separation distance between the at least two boundaries on the medium.

14. The method of claim 13, wherein the at least two boundaries comprise a bleed boundary and an art boundary and the separation distance is the separation distance between the bleed boundary and the art boundary.

15. The method of claim 13, wherein the at least two boundaries comprise a bleed boundary and a trim boundary and the separation distance is the separation distance between the bleed boundary and the trim boundary.

16. An apparatus for printing a graphical work on a medium, the apparatus comprising:
a memory capable of storing a file comprising the graphical work and at least one boundary associated with the graphical work;
a processor configured and arranged to direct printing of the graphical work and an indication of the at least one boundary onto the medium.

17. The apparatus of claim 16, further comprising a printer coupled to the processor and configured and arranged to print the graphical work and the indication of the at least one boundary onto the medium.
